(19) United States
(12) Patent Application Publication
(10) Pub. No.: US 2013/0216136 A1
(43) Pub. Date: Aug. 22, 2013

(54) IMAGE PROCESSING APPARATUS, IMAGE PROCESSING METHOD, STORAGE MEDIUM AND IMAGE PROCESSING SYSTEM

(71) Applicant: CASIO COMPUTER CO., LTD., (US)

(72) Inventors: Kazunori KITA, Nishitama-gun (JP); Masaru SAKATA, Higashiyamato-shi (JP)

(73) Assignee: CASIO COMPUTER CO., LTD., Tokyo (JP)

(21) Appl. No.: 13/764,434

(22) Filed: Feb. 11, 2013

(30) Foreign Application Priority Data
Feb. 16, 2012 (JP) 2012-031476

(51) Int. Cl. G06K 9/46

(52) U.S. Cl. CPC G06K 9/46
USPC 382/195

(57) ABSTRACT

An image processing method includes shooting a subject and an object different from the subject, extracting a characteristic of the object, and converting an image of the subject into a character image according to the extracted characteristic of the object.

### CROSS-REFERENCE TO RELATED APPLICATIONS

This application is based upon and claims the benefit of priority from prior Japanese Patent Application No. 2012-031476, filed Feb. 16, 2012, the entire contents of which are incorporated herein by reference.

### BACKGROUND OF THE INVENTION

1. Field of the Invention

The present invention relates to an image processing apparatus configured to create a character image such as an image of a character appearing in an animation or the like, an image processing method, a storage medium, and an image processing system.

2. Description of the Related Art

In the present specification, a character image includes an image of a non-live-action person appearing in an animation.

An illustration is similar to a character image. Jpn. Pat. Appln. KOKAI Publication No. 2004-102819 describes therein a technique configured to create an illustrative image from a photographic image. However, this is just an “illustrative” expression of a photograph, and a character image in the present specification is an image of a person or the like having a different personality from that in a photograph. According to the Oxford Advanced Learner's Dictionary, an “illustration” is “a drawing or picture in a book, magazine, etc. especially one that explains something”, and “character” is “a person or an animal in a bock, play, or film/movie.”

For the character image, anime degree is discussed in reference (KAWATANI Hirokazu et al. (Hokkaido University), “Anime Degree Evaluation by Feature Extraction of Animation Characters and its Applications” FIT 2008 (The seventh Forum on Information Technology), I-040, 2008), for example. A simple method for shooting a person and converting it into a character image is to prepare a database of many character images and to select a character image best matching a characteristic of the subject (see Jpn. Pat. Appln. KOKAI Publication No. 2004-313225).

A characteristic of a subject may be gender, color, brightness, contour, or the like by way of example. If a face recognition technology is applied, a more detailed characteristic such as size of eyes or aspect ratio of the face can be extracted.

On the other hand, many character images stored in the database are associated with a plurality of items of characteristic information, a match with the characteristic information extracted from the subject is found, and a character image with the highest match may be selected.

In this way, in the conventional technique, a match with the characteristic information extracted from the subject is found and a character image with the highest match is selected, thereby converting the subject into the character image. Thus, the characteristic of the subject can be reflected on the character image, while a persona is converted into only a character image with the highest match.

That is, since the characteristic of the subject person is a fact, the character image converted in accordance with such fact and the person always have a correspondence, and basically the same person is converted into the same character image. Thus, there is a small variety of character images.

Naturally, if the character image converted by the technique is edited by use of CG (Computer Graphics), a character image with a different characteristic or image added to a person can be created. However, the image edited by the CG technique requires specialist knowledge and sophisticated technology, thus it is difficult for a typical user and cannot be performed easily and rapidly.

### BRIEF SUMMARY OF THE INVENTION

The present invention has been made in view of the above conventional problem, and an object of the invention is to provide an image processing apparatus configured to easily and rapidly create a character image added with a characteristic capable of being freely selected that differs from a characteristic of a subject; as well as to provide an image processing method, a storage medium, and an image processing system.

In order to solve the problem, according to the present invention, an image processing method includes shooting a subject and an object different from the subject, extracting a characteristic of the object, and converting an image of the subject into a character image according to the extracted characteristic of the object.

That is, to shoot a subject and to convert the subject into a character image, another object is shot so that the subject is converted into a character image according to a characteristic of the object.

According to the present invention, a character image added with a characteristic different from a characteristic of a subject can be easily and rapidly created.

### BRIEF DESCRIPTION OF THE SEVERAL VIEWS OF THE DRAWING

FIG. 1 is a block diagram illustrating a structure of a digital camera according to one embodiment of the present invention.

FIG. 2 is a conceptual diagram illustrating a structure of a network according to the present embodiment.

FIG. 3 is a block diagram illustrating a structure of an image service site.

FIG. 4A is a conceptual diagram illustrating the structures of a first database in the image service site.

FIG. 4B is a conceptual diagram illustrating the structures of a second database in the image service site.

FIG. 5 is a flowchart illustrating a processing procedure of the digital camera and the image service site.

FIG. 6 is a flowchart illustrating a detailed processing of detecting the face of a subject in step S102 in FIG. 5.

FIG. 7A is a diagram illustrating an exemplary mask pattern for extracting a region of an eye in the face.

FIG. 7B is a diagram illustrating a diagram illustrating exemplary condition data of an eye recognition region.

FIG. 7C is a diagram illustrating exemplary condition data of a face recognition region.

FIG. 8A is a diagram illustrating an exemplary first shot image.

FIG. 8B is a diagram illustrating an exemplary clipped image of a person's face.

FIG. 9 is a flowchart illustrating a detailed processing of detecting an object in step S106 in FIG. 5.

FIG. 10A is a diagram illustrating an exemplary second shot image.

FIG. 10B is a diagram illustrating an exemplary clipped object.

FIG. 11 is a diagram for explaining an exemplary processing procedure of extracting a characteristic of a region of the person's face.

FIG. 12 is a flowchart illustrating an exemplary processing procedure of extracting a characteristic of an object.

FIG. 13 is a transition diagram illustrating a first example in which a shot image is converted into a character image.

FIG. 14 is a transition diagram illustrating a second example in which a shot image is converted into a character image.

FIG. 15 is a transition diagram illustrating a third example in which a shot image is converted into a character image.

FIG. 16 is a transition diagram illustrating a fourth example in which a shot image is converted into a character image.

### DETAILED DESCRIPTION OF THE INVENTION

An embodiment of an image processing apparatus according to the present invention will now be described with reference to the accompanying drawings.

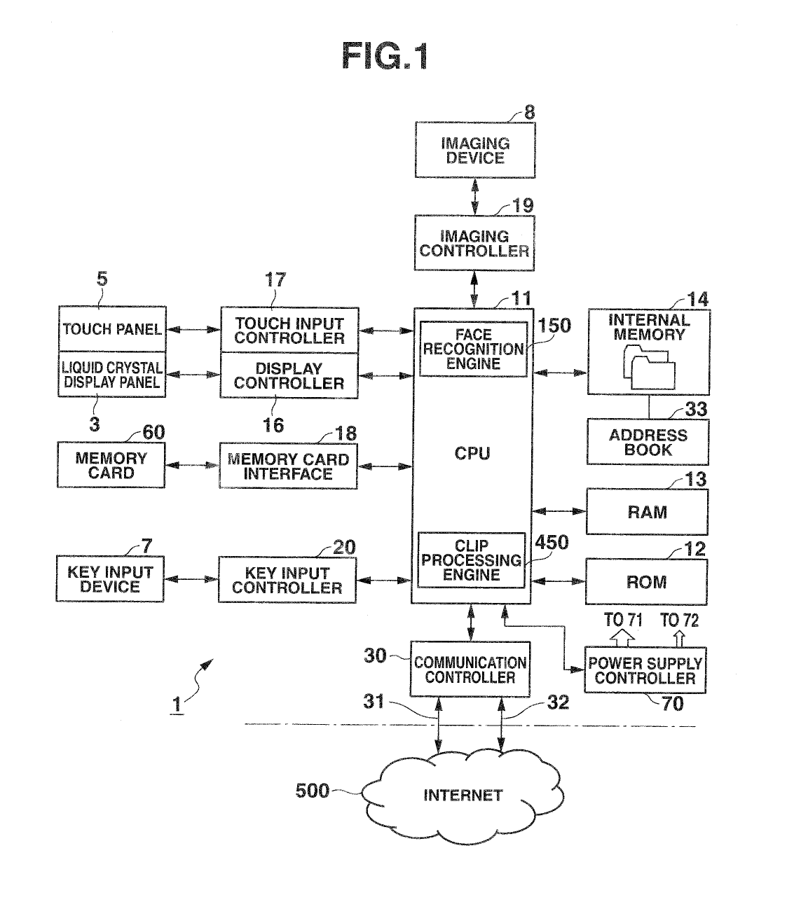

An embodiment of the present invention will be described below. FIG. 1 is a block diagram illustrating an electrical structure of a digital camera 1 according to the embodiment to which the present invention is applied. The digital camera 1 has a communication function and includes a CPU 11, a ROM 12 connected to the CPU 11, a RAM 13, and an internal memory 14. The ROM 12 stores therein programs for causing the CPU 11 to perform the operations in the flowcharts described later. The CPU 11 includes a face recognition engine 150 configured to perform a face recognition processing on the face shot by an imaging device 8, and a clip processing engine 450 configured to clip a face image.

The face recognition engine 150 is capable of recognizing each face when one or a plurality of faces are shot in a photograph. The face recognition engine 150 is configured with ASIC (Application Specific Integrated Circuit), DSP (Digital Signal Processor), or reconfigurable LSI (LSI reconfigurable by a program such as C language) in cooperation with the CPU 11.

The clip processing engine 450 performs a processing of clipping a face image in the flowchart described later. The RAM 13 is a work memory configured to temporarily store various items of data by the CPU 11 as needed.

The internal memory 14 is a large-capacity nonvolatile memory such as hard disk or flash memory.

A display controller 16 drives a liquid crystal display panel 3 based on display image data supplied from the CPU 11 thereby to display images or various menus on the liquid crystal display panel 3. A touch input controller 17 is directed for inputting an operation signal of a touch panel 5 under control of the CPU 11. An electro luminescence (EL) panel can be used instead of the liquid crystal display panel 3.

The touch panel 5 may be appropriately selected from among an electrostatic capacity system, optical system, resistance film system, surface acoustic wave system, ultrasonic wave system and electromagnetic induction system. The functions of fingerprint authentication and vein authentication may be incorporated.

A memory card interface 18 is an I/O interface configured to control input/output of data between various memory cards 60 removably inserted into a memory card slot (not shown) and the CPU 11.

A key input device 7 includes keys typically arranged in the digital camera such as a shutter key or a power supply key. A key input controller 20 scans the key input device 7 under control of the CPU 11, and fetches an operation signal of the key.

An imaging controller 19 drives the imaging device 8 to capture an image of a subject. Image data captured in Bayer data is converted into YUV and RGB data, is compressed into JPEG (Joint Photographic Experts Group) data, and is recorded in the internal memory 14 or the memory card 60.

A power supply controller 70 takes in DC power via a battery (not illustrated) and supplies power of a main power supply 71 or standby power supply 72 to each part.

A communication controller 30 connects to Internet 500 via a cell phone line 31 or wireless LAN 32 to exchange e-mails or to perform communication control such as contents exchange. An address book 33 is used for exchanging e-mails, and is actually provided in the internal memory 14.

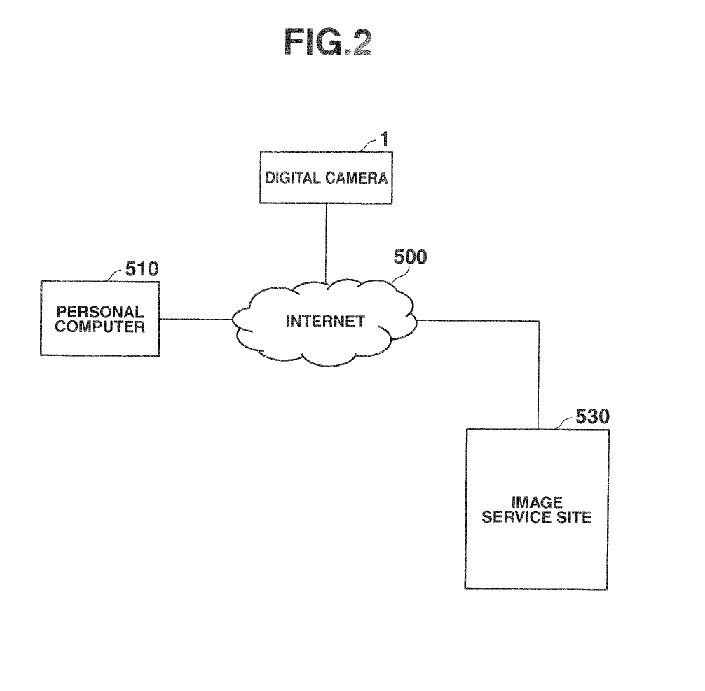

FIG. 2 is a conceptual diagram illustrating a structure of a network according to the present embodiment. A personal computer 510 can be connected to the digital camera 1 via the communication controller 30 by the wireless LAN 32 and can perform complicated settings that cannot be performed by the digital camera 1.

An image service site 530 functions as an extracting unit configured to extract a characteristic of an object from an image of the object different from a subject shot and transmitted by the digital camera 1, and as a converting unit configured to convert the image of the subject shot and transmitted by the digital camera 1 into a character image according to the extracted characteristic of the object. The object is a subject to be shot in order to give a character image to be created independently from a subject to be converted into a character image.

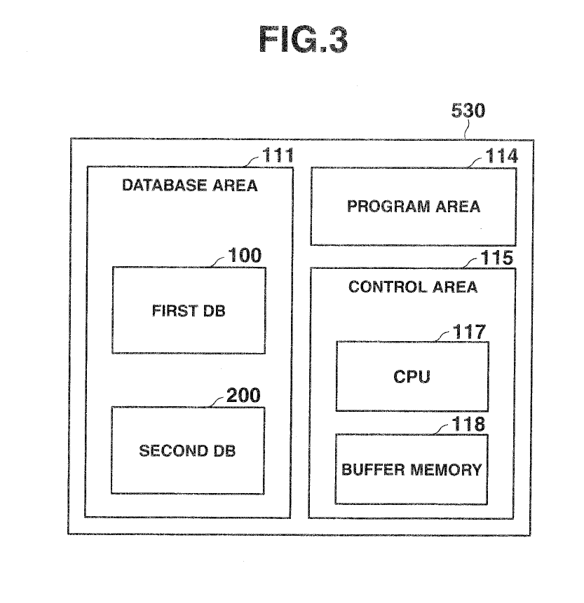

FIG. 3 is a block diagram illustrating a structure of the image service site 530. The image service site 530 is formed of a DB (database) area 111, a program area 114, and a control area 115. The DB area 111 is provided with a first DB 100 and a second DB 200. The program area 114 stores therein programs for executing various processings indicated in the flowcharts described later. The control area 115 includes a CPU 117 or a buffer memory 118.

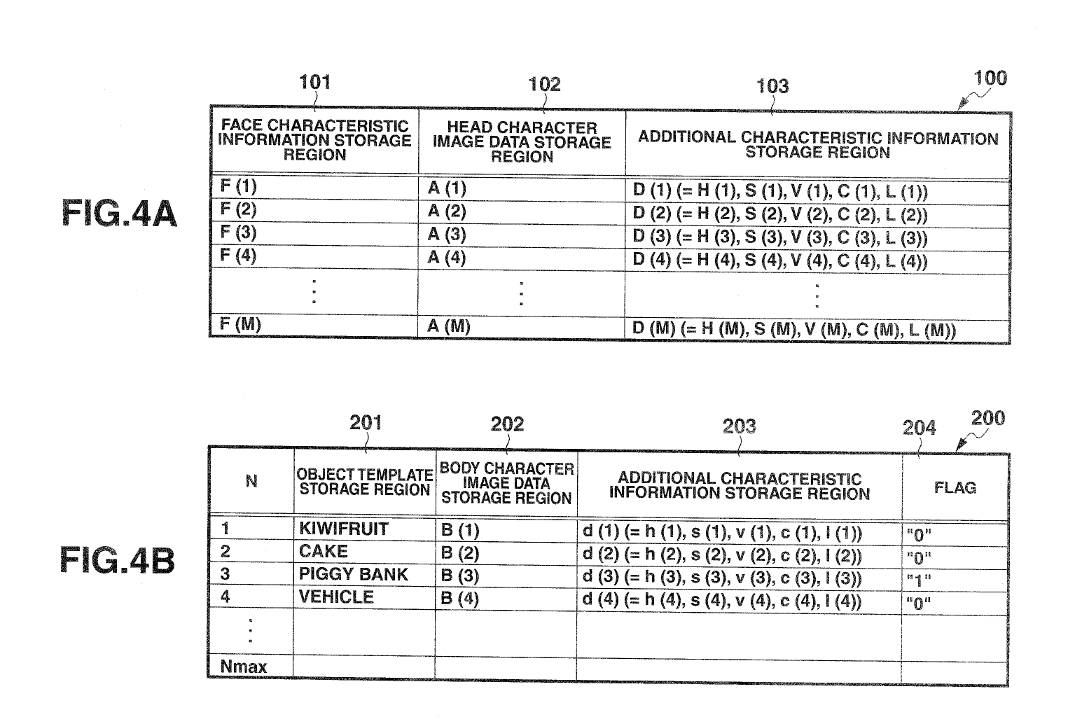

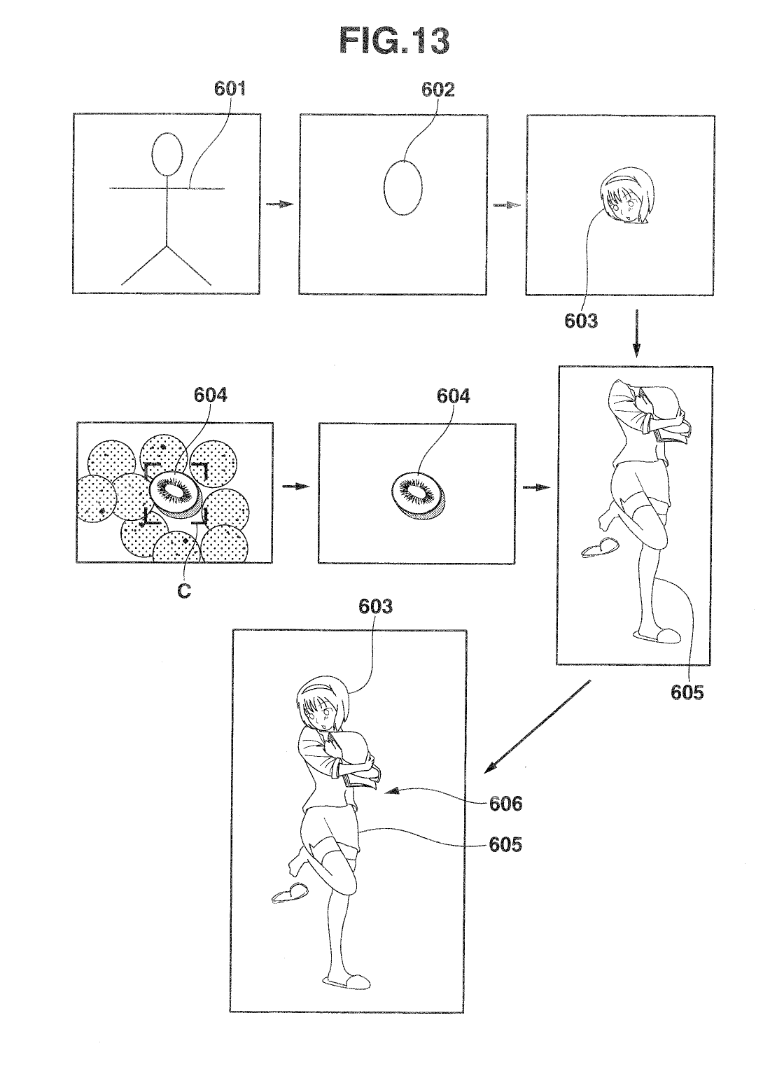

The first DB 100 is divided into a person's face characteristic information storage region 101, a head character image data storage region 102, and an additional characteristic information storage region 103 as illustrated in FIG. 4A. The person's face characteristic information storage region 101 stores therein face characteristic information indicating a characteristic of a face, described later, in each characteristic amount F(1), F(2), F(3), F(4), . . . in a divided manner. The head character image data storage region 102 stores therein the head character image data A(1), A(2), A(3), A(4), . . . for displaying the head image with the neck and the face including hair in a character image in correspondence with each characteristic amount F(1), F(2), F(3), F(4), . . . as illustrated in 603, 703, 803 and 903 in FIGS. 13 to 16. The additional characteristic information storage region 103 stores therein characteristic data D(1), D(2), D(3), D(4), . . . corresponding to the head character images A(1), A(2), A(3), A(4), . . . . The characteristic data D(i) includes hue H(i), saturation S(i), brightness V(i), contour C(i), and size L(i). Parameter “i” is any integer between 1 and M.

The second DB 200 is divided into an object template storage region 201, a body character image data storage region 202, an additional characteristic information region 203, and a flag region 204 per serial number N=1, 2, 3, 4, . . . as illustrated in FIG. 4B. The object template storage region 201 stores therein characteristic information indicating characteristics of objects other than people, such as “kiwifruit”, “cake”, “piggy bank” and “vehicle” (respective items of characteristic data such as hue, saturation, brightness, contour and size in the present embodiment) as templates. The body character image data storage region 202 stores therein body character image data B(1), B(2), B(3), B(4), . . . as illustrated in 605, 705, 805 and 905 in FIGS. 13 to 16, described later, corresponding to each template. The additional characteristic information storage region 203 additionally stores therein the characteristic data d(1), d(2), d(3), d(4), . . . corresponding to the body character image data B(1), B(2), B(3), B(4), . . . . The characteristic data d(j) includes hue h(j), saturation s(j), brightness v(j), contour c(j), and size l(j). Parameter “j” is any integer between 1 and Nmax. A similarity flag indicative of a similarity between the template and the object is set in the flag region 204.

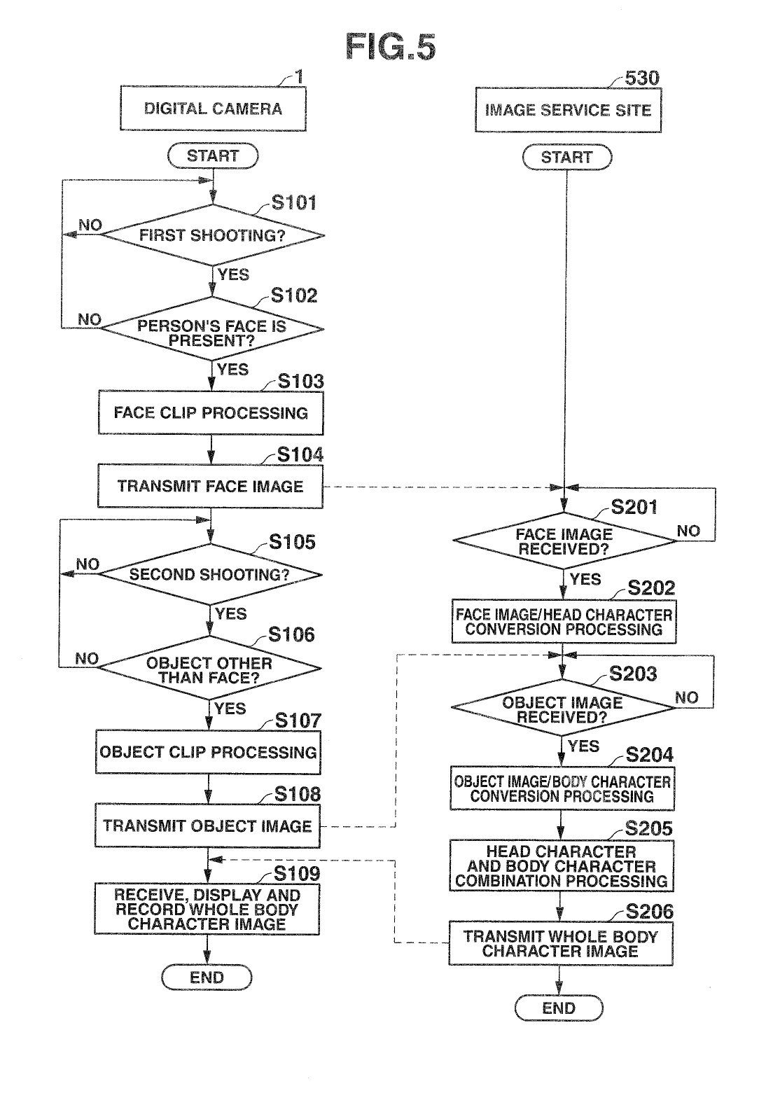

The operations in the present embodiment with the above structure will be described below with reference to the flowchart of FIG. 5. The left side is of the digital camera processing and the right side is of the image service site processing. When the digital camera 1 is set in the character image creation mode, the CPU 11 performs the processing according to a program stored in the ROM 12 to operate as illustrated in the flowchart on the left side of FIG. 5. The CPU 117 performs the processing according to a program stored in the program area 114 so that the image service site 530 operates as illustrated in the flowchart on the right side of FIG. 5.

That is, the digital camera 1 waits for the first shooting processing to be performed (step S101). When the user operates the shutter key provided in the key input device 7, the imaging controller 19 drives the imaging device 8 in response to an instruction from the CPU 11. Thereby, the image data fetched in Bayer data from the imaging device 8 is converted into YUV and RGB data by the imaging controller 19 and is compressed into JPEG data to be recorded in the internal memory 14 or the memory card 60.

Then, the determination in step S101 is YES, and the CPU 11 proceeds from step S101 to step S102 to determine whether a person face is present in the recorded image.

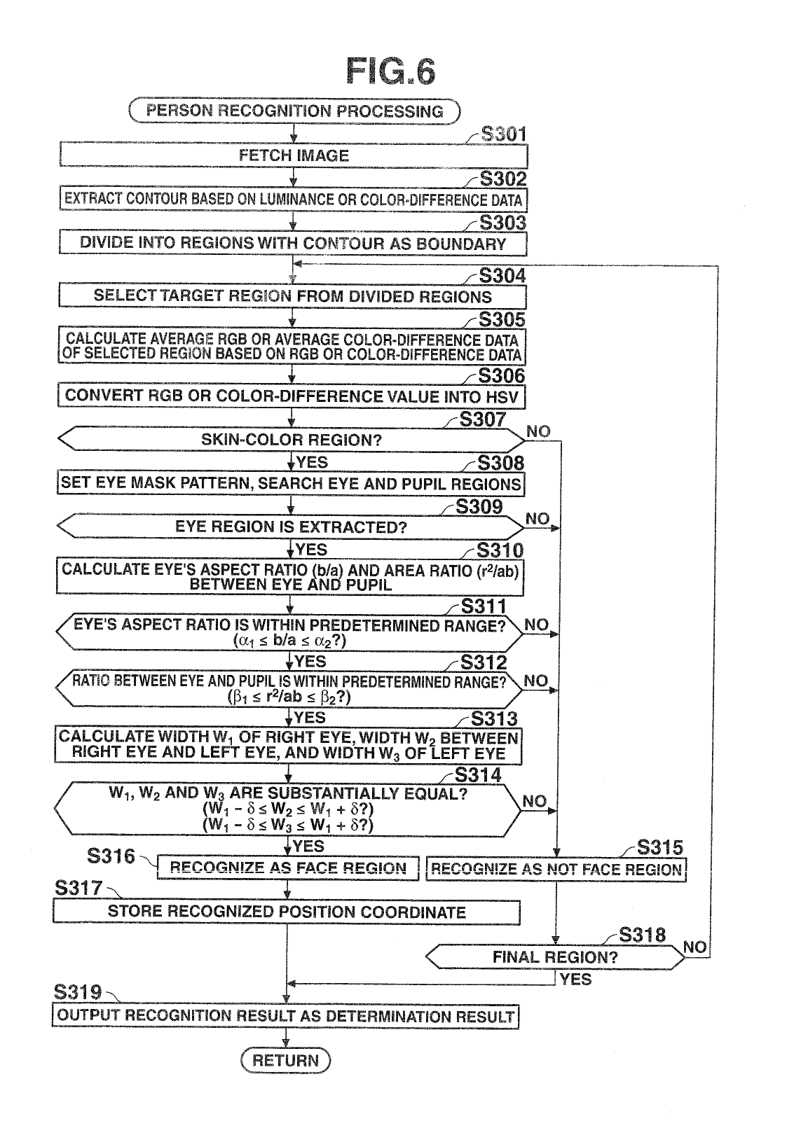

FIG. 6 is a flowchart illustrating detailed step S102 as a processing of detecting the face of the subject. At first, the image recorded in the internal memory 14 or the memory card 60 is fetched as described above (step S301). A contour is extracted based on luminance or color-difference data (step S302). The contour is not limited to a closed curve, and may be a curve with the start point/end point at the peripheral edges of the frame. The number of contours is not limited to one, and may be multiple. The image is divided into a plurality of regions with the extracted contour as a boundary (step S303). Any region is selected as a target region from the divided regions (step S304). Average RGB or average color-difference data of the selected region is calculated based on RGB or color-difference data (step S305). The calculated average RGB or average color-difference data is converted into HSV (step S306).

Subsequently, it is determined whether the converted HSV is of a skin-color region or whether the hue is between 6 and 38 degrees (step S307). When the determination is NO, it is determined that the target region is not a face region (step S315). It is determined whether the currently-selected target region is the final region in the image (step S318). When it is not the final region, the processing returns to step S304 to select a next region and to repeat the above processing. When the above processing is performed up to the final region, the determination in step S318 is YES, and the recognition result is output as a determination result (step S319).

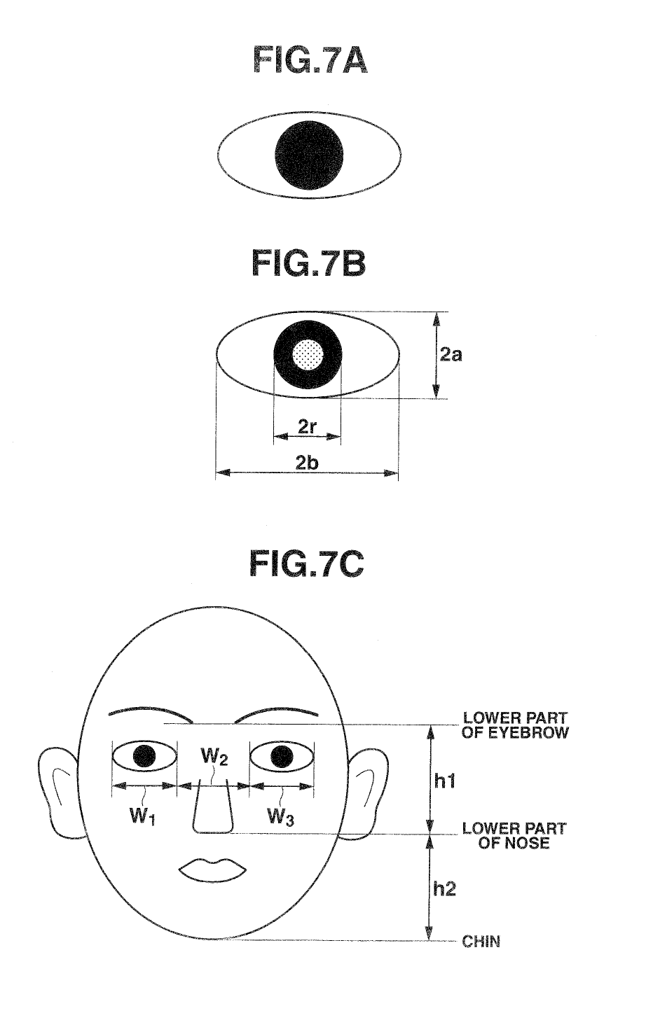

When the determination in step S307 is YES, a face mask pattern illustrated in FIGS. 7A, 7B and 7C is used to search eye and pupil regions in the target region (step S308).

FIG. 7A illustrates an exemplary mask pattern for extracting an eye region in the face, and a search is made using template matching with the mask pattern as a reference pattern, thereby searching an image region including an eye or the face from the input image.

FIG. 7B illustrates exemplary data for recognizing an eye, and a region of the subject image matching with the condition of α₁≦b/a≦α₂ (where eye length=b/a) can be identified as “eye region.” Assuming S₁ (area of eye)≈π×a×b, S₂ (area of black eye (pupil)≈π×r², and S₂/S₁ (ratio of black eye (pupil))=r²/ab, a region of the subject image matching with the condition such as β₁≦r²/ab≦β₂ can be identified as “eye region.” FIG. 7C illustrates the setting of the condition data for recognizing a person's face, and a region of the subject image meeting the conditions such as h₁ (length between lower part of eyebrow and lower part of nose)≈h₂ (length between lower part of nose and chin) or W₁ (width of right eye)≈W₂ (width between both eyes)≈W₃ (width of left eye) can be identified as “face region.”

The face mask pattern illustrated in FIGS. 7A, 7B and 7C is used to search the eye and pupil regions in the target region (step S308). It is determined whether the eye region can be detected (step S309), and when it cannot be detected, it is determined that a face region is not detected (step S315). When detected, an eye's aspect ratio (b/a) and an area ratio (r²/ab) between eye and pupil are calculated (step S310), and it is determined whether the eye's aspect ratio is within a predetermined range or meets the condition of α₁≦b/a≦α₂ (step S311). When the determination is NO, it is determined that a face region is not detected (step S315).

When the determination in step S311 is YES, it is determined whether the ratio between eye and pupil is within a predetermined range or meets the condition of β1≦r²/ab≦β2 (step S312). When the determination is NO, it is determined that a face region is not detected (step S315). When the determination in step S312 is YES, the width W₁ of the right eye, the width W₂ between the right eye and the left eye, and the width W₃ of the left eye are calculated (step S313), and it is determined whether W₁ is equal to W₂ and W₃ or W₁−δ≦W₂≦W₁+δ and W₁−δ≦W₃≦W₁+δ are established (step S314). When the determination is NO, it is determined that a face region is not detected (step S315). When the determination is YES, or all the determinations in steps S307, S309, S311, S312 and S314 are YES, the region selected in step S304 is recognized as a face region (step S316). The position coordinate of the recognized face region is stored (step S317), and the recognition result is output as a determination result (step S319).

Thus, with the above processing, when it is determined that a person's face is present in the image in step S102 in the flowchart of FIG. 5, YES is output, and when a person's face is not present, NO is output. When YES is output, the processing of clipping the determined face image (face part) is performed. The clip processing is performed by clipping the image part recognized as a face region in step S316 which is a contour extracted in step S302. The clipped face image is transmitted to the image service site 530 (step S104).

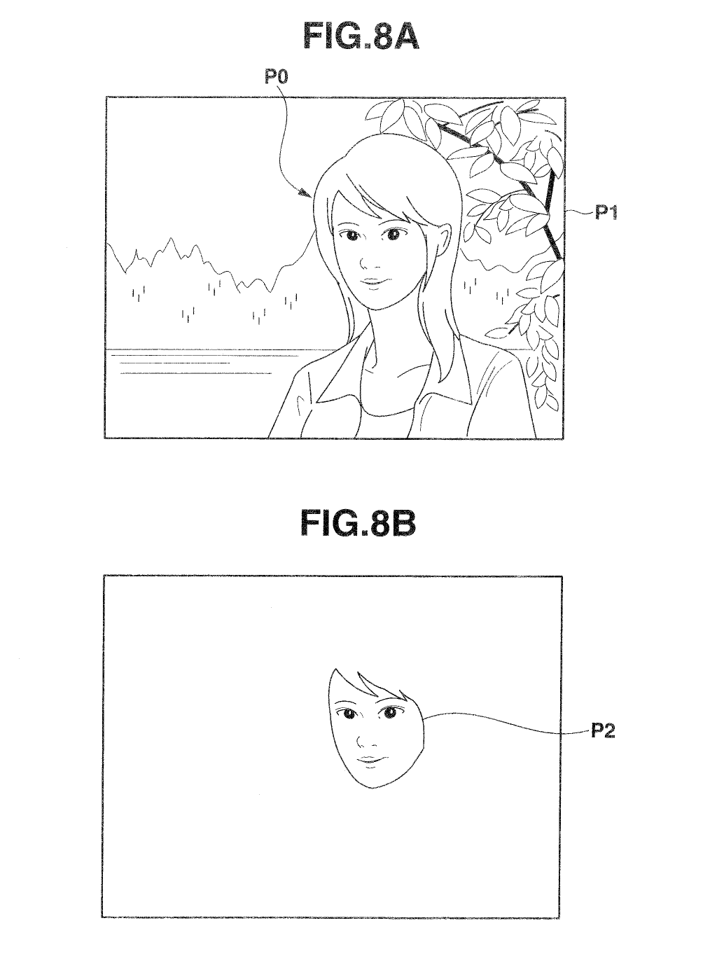

Thus, assuming that an image P1 in which a person P0 having the face illustrated in FIG. 8A is present is shot by the first shooting, for example, the face part P2 is clipped out of the person P0 as illustrated in FIG. 8B and its image data is transmitted from the digital camera 1 to the image service site 530.

In the present embodiment, the processing of clipping the face image (face part) (step S103) is performed in the digital camera 1 and the clipped face image is transmitted to the image service site 530. However, the image shot at the first time is transmitted to the image service site 530 and the clip processing may be performed in the image service site 530.

In this way, processing loads of the digital camera 1 having a lower processing capability than the server (the image service site 530) can be reduced, and the clip processing can be performed accurately and rapidly in the server (the image service site 530) having a high processing capability.

Then, the digital camera 1 waits for the second shooting processing to be performed (step S105 in FIG. 5). When the user operates the shutter key provided in the key input device 7, as described above, the imaging controller 19 drives the imaging device 8 in response to an instruction from the CPU 11, and the image data fetched in Bayer data from the imaging device 8 is converted into YUV and RGB data by the imaging controller 19 and is compressed into JPEG data to be recorded in the internal memory 14 or the memory card 60.

The determination in step S105 is YES, and the CPU 11 proceeds from step S105 to step S106 to determine whether an object other than a person's face is present at the center of the image, for example.

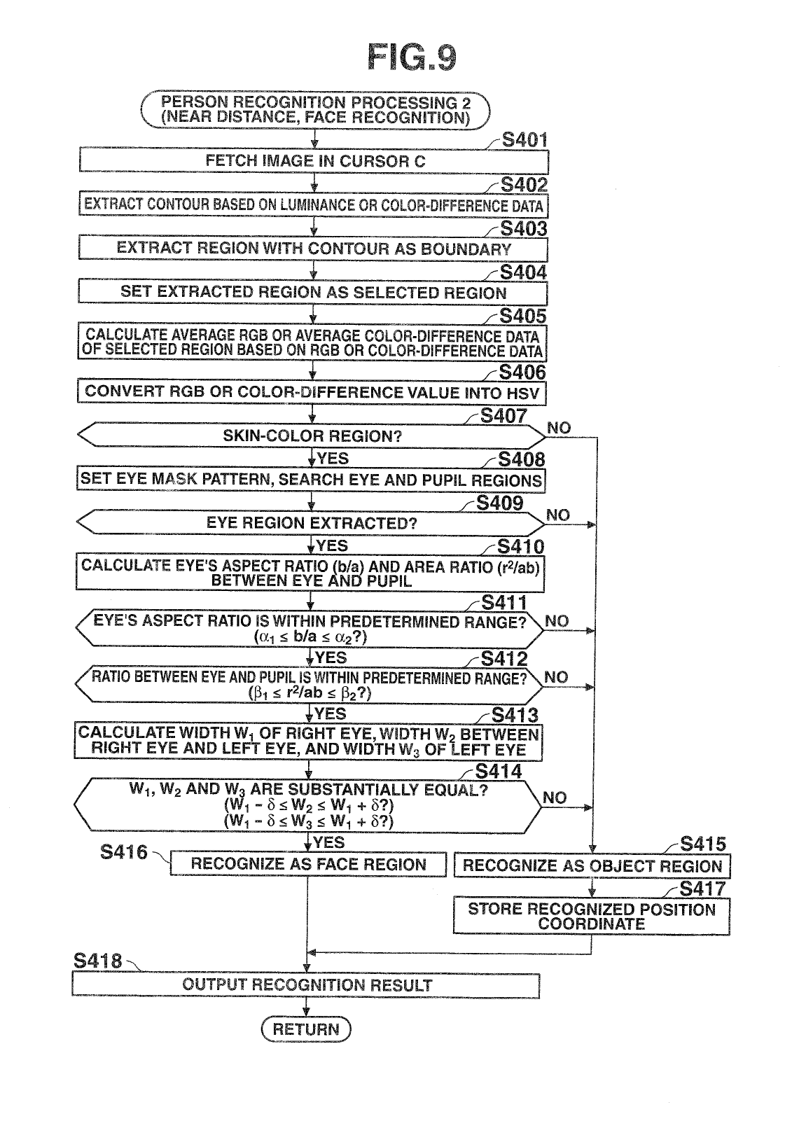

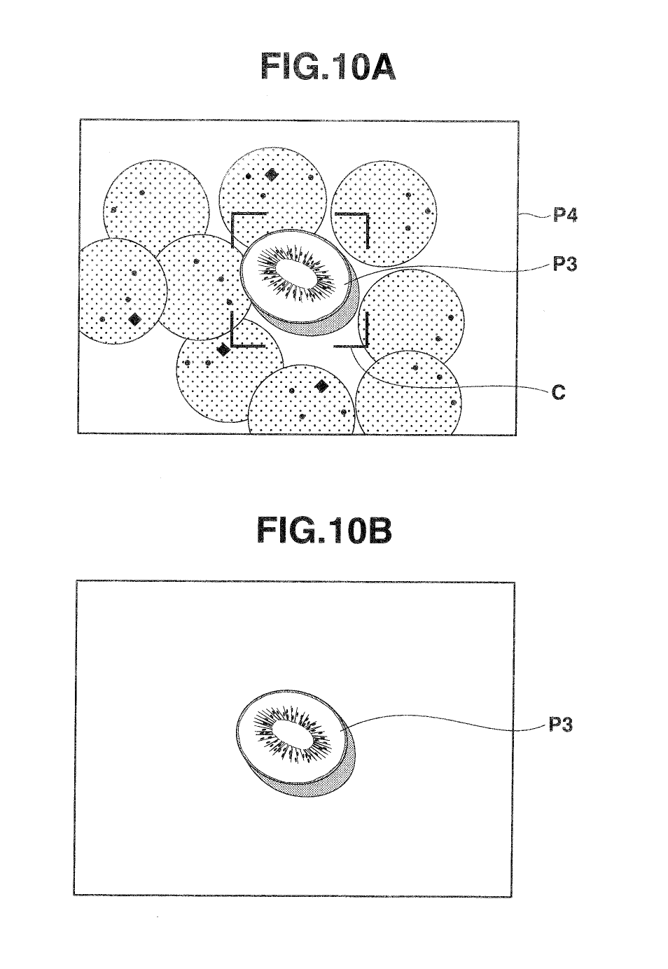

FIG. 9 is a flowchart illustrating detailed step S106 as a processing of detecting an object other than a person's face. At first, the center part of the image surrounded by the cursor C (see FIG. 10A) in the image recorded in the internal memory 14 or the memory card 60 as described above is fetched (step S401). A contour is extracted based on luminance or color-difference data (step S402). Then, a region in the image with the extracted contour as a boundary is extracted (step S403). The extracted region is assumed as a selected region (step S404). Average RGB or average color-difference data of the selected region is calculated based on RGB or color-difference data (step S405). The calculated RGB or color-difference value is converted into HSV (Hue, Saturation, Value) (step S406).

Subsequently, it is determined whether the converted HSV is of a skin-color region or whether a hue is between 6 and 38 degrees (step S407). When the determination is NO, it is determined that the target region is a region of an object other than a face (step S415). Further, the position coordinate of the recognized object region is stored (step S417). The recognition result is output as a determination result (YES) (step S419).

When the determination in step S407 is YES, the face mask pattern illustrated in FIG. 7A is used to search the eye and pupil regions in the target region (step S408). Then, it is determined whether an eye region is detected (step S409). When an eye region is not detected, it is determined that the target region is an object region (step S415). When detected, an eye's aspect ratio (b/a) and an area ratio (r²/ab) between eye and pupil are calculated (step S410). It is determined whether the eye aspect ratio is within a predetermined range or whether the condition of α₁≦b/a≦α₂ is met (step S411). When the determination is NO, it is determined that the target region is an object region (step S415).

When the determination in step S411 is YES, it is determined whether the ratio between eye and pupil is within a predetermined range or whether the condition of β₁≦r²/ab≦β₂ is met (step S412). When the determination is NO, it is determined that the target region is an object region (step S415). When the determination in step S412 is YES, the width W₁ of the right eye, the width W₂ between the right eye and the left eye, and the width W₃ of the left eye are calculated (step S413). It is determined whether W₁ is equal to W₂ and W₃ or whether W₁−δ≦W₂+W₁+δ and W₁−δ≦W₃≦W₁+δ are established (step S414). When the determination is NO, it is determined that the target region is an object region (step S415). When the determination is YES or all the determinations in steps S407, S409, S411, S412 and S414 are YES, the region selected in step S404 is recognized as a face region and not an object region (step S416). The recognition result is output as a determination result (NO) (step S418).

Thus, with the above processing, if it is determined that an object other than a person's face is present at the center of the image in step S106 in the flowchart on the left of FIG. 5, YES is output. When YES is output, the processing of clipping the determined object is performed (step S107). The clip processing is performed by clipping out the image part recognized as an object region in step S415, which is a contour extracted in step S402. The clipped object image is transmitted as an object image to the image service site 530 (step S108).

Thus, assuming that with the second shooting, an image P4 where a kiwifruit P3 is present within the cursor C displayed at the center is shot in the live view image displayed in the liquid crystal display panel 3 as illustrated in FIG. 10A, for example, the kiwifruit P1 is clipped out of the image P4 as illustrated in FIG. 10B, and its image data is transmitted as object image data from the digital camera 1 to the image service site 530.

On the other hand, the image service site 530 determines whether to receive the face image data transmitted from the digital camera 1 in step S104 (step S201). When the face image data is received, a head character image conversion processing is performed (step S202). The head character image conversion processing includes the following processings (1) and (2).

(1) Processing of extracting a characteristic of a face image expressed in received face image data

(2) Processing of reading head character image data A(i) corresponding to the extracted characteristic from the first DB 100

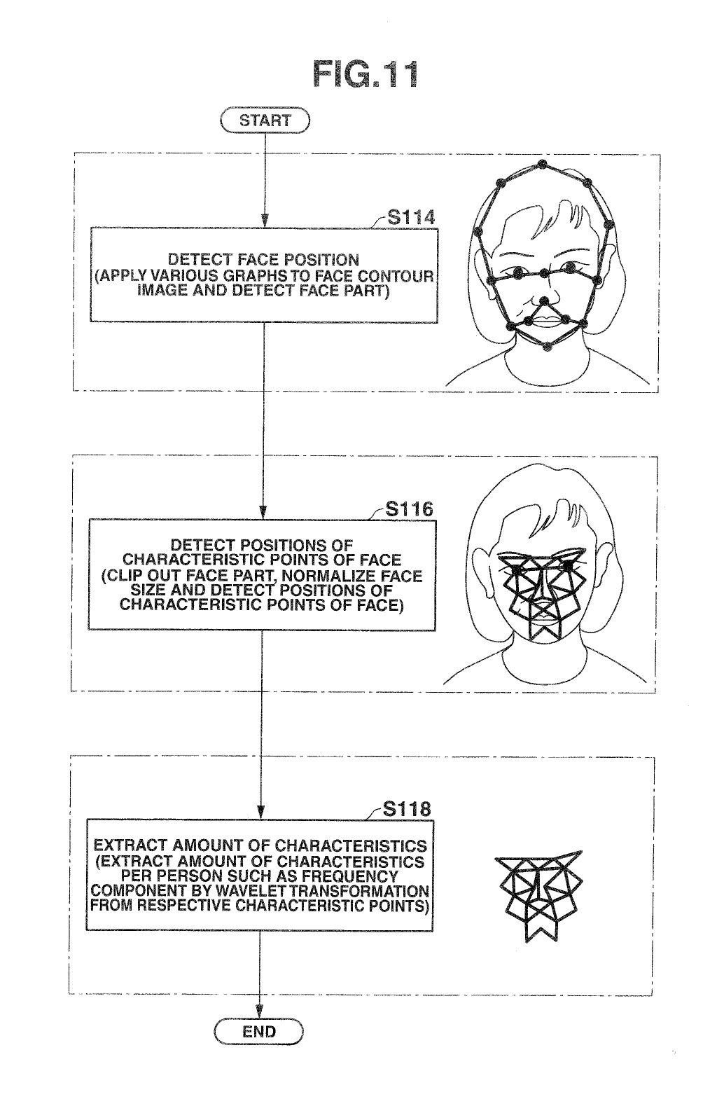

FIG. 11 is an explanatory flow diagram illustrating an exemplary processing procedure of extracting a characteristic of a face in processing (1). That is, in step S114 (face position detection), various graphs are applied to a face contour image thereby to detect a face image of a person. Then, in step S116 (position detection of characteristic points of face), a face image in the image is clipped out and the size of the face is normalized thereby to detect the positions of the characteristic points of the face. In step S118 (characteristic amount extraction), the amount of characteristics F for each person, such as a frequency component, is extracted by wavelet transformation or the like from the image of the respective characteristic points.

Assuming that the range in which the amount of characteristics F between the minimum value and the maximum value is 1000, in FIG. 4A, when the amount of characteristics F(1) is 1 to 10, F(2) is 11 to 20, F(3) is 21 to 30, . . . F(100) is 991 to 1000, they correspond to the corresponding head character image data A(1), A(2), A(3), . . . A(100), respectively.

In this example, the range of the amount of characteristics is divided into 1000 and the characteristics are associated with the 100 head character images (hereinafter, an image indicated by head character image data will be referred to as a head character image), but a correspondence or the number of head character images may be set as needed.

Thus, in this example, the person's face characteristic information storage region 101 in the first DB 100 illustrated in FIG. 4A stores therein the amounts of characteristics F(1), F(2), F(3), F(4), . . . and the head character image data storage region 102 stores therein different head character image data A(1), A(2), A(3), A(4), . . . corresponding to the amounts of characteristics, respectively. The, the head character image data corresponding to the amount of characteristics is read in the processing (2) so that the character image conversion processing (S202) is completed.

In the flowchart on the right of FIG. 5, in step S203 subsequent to S202, it is determined whether the object image data transmitted from the digital camera 1 is received. When the object image data is received, the body character image conversion processing is performed (step S204). The body character image conversion processing includes the following processings (3) and (4).

(3) Processing of extracting a characteristic of an object expressed by the received object image data

(4) Processing of reading body character image data B(j) corresponding to the extracted characteristic of object from the second DB 200

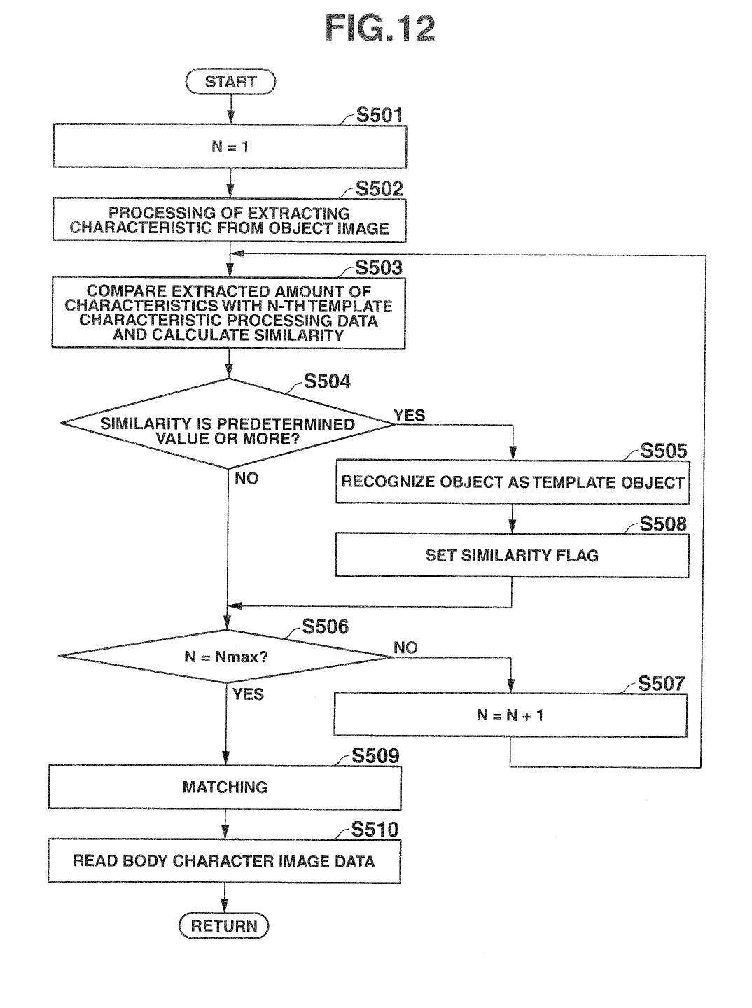

FIG. 12 is a flowchart illustrating an exemplary processing procedure of extracting a characteristic of an object in processing (3). The CPU 117 in the image service site 530 performs the processing illustrated in the flowchart of FIG. 12 based on a program stored in the program area 114. That is, an initial value “1” is set in a counter N configured to count a serial number N assigned to a row in the second DB 200 (step S501).

Subsequently, the processing of extracting a characteristic from the received object image is performed (step S502). In the present embodiment, the characteristics to be extracted are assumed as hue, saturation, brightness, contour and size. Thus, with the processing in step S502, the buffer memory 118 stores therein characteristic data d(0) of the object image such as hue h(0), saturation s(0), brightness v(0), contour c(0), and size l(0).

Then, the characteristic data d(0) including hue h(0), saturation s(0), brightness v(0), contour c(0), and size l(0) stored in the buffer memory 118 is compared with characteristic data d(N) including hue h(N), saturation s(N), brightness v(N), contour c(N), and size l(N)) associated with body character image data B(N) stored in the storage region 202 for an N-th row in the second DB 200, thereby calculating similarities (step S503). That is, a ratio between each value of the extracted characteristic data d(0) and each value of the stored characteristic data d(N) is calculated.

Then, it is determined whether the similarity as the calculated ratio is equal to or more than a predetermined value (step S504). When it is less than the predetermined value, the processing proceeds to step S506. Then, until the value of N reaches the maximum value Nmax of the rows in the second DB 200, the value of N is incremented (step S507) and the processing after step S503 is repeated. When the similarity is equal to or more than the predetermined value, the object is recognized as one of template objects (step S505). Thus, when the similarity is equal to or more than the predetermined value, the object is specified as an object other than a person, such as “kiwifruit”, “cake”, “piggy bank” and “vehicle.”

For example, the similarity equal to or more than the predetermined value is assumed as 0.9 to 1.1 (1.0=match). When it is determined that the similarity between hue h(0) in the characteristic data d(0) of the shot and extracted object and hue h(1) in the characteristic data D2 associated with the body character image data B(1) on the first row (N=1) in the second DB 200 is 0.8, the similarity is out of the predetermined range, and the processing proceeds to a comparison for the second row (N=2). When it is determined that the similarity of hue on the second row is 1.05, the similarity is within the predetermined range, and thus the processing proceeds to a comparison of saturation for the second row. When the similarity is within the predetermined range such as 0.98, the processing proceeds to a comparison of brightness for the second row. If the similarity of brightness is out of the predetermined range such as 1.2, the comparison for the second row is terminated and the processing proceeds to a comparison for the third row. When it is determined that all the elements in the characteristic data d(3) associated with the body character image data B(3) on the third row are within the predetermined range, it is determined that the body character image on the third row (hereinafter, an image expressed by body character image data will be referred to as body character image) is similar to the shot object, and a similarity flag is set in the flag region 204 of the second DB 200 (step S508).

The similarity comparison processing is performed until Nmax, and consequently it is assumed that 10 items of body character image data with a similarity flag are present. Then, matching with the head character image determined in the DB 100 is found (step S509). That is, since the head character image is similar to the subject's face and the body character image is similar to the object, data which is most similar to the preset head character image is selected from among the ten items of body character image data with a similarity flag. Specifically, the head character images A(1), A(2), A(3), . . . each have the characteristic data D(1), D(2), D(3), . . . including hue, saturation, brightness, contour, and size, the similarities are compared between the characteristic data d(j) associated with the ten items of body character image data B(j) with a similarity flag and the characteristic data D(i) of the determined head character image A(i), and a body character image B(j) whose average similarities of the respective elements are closest to 1 is specified.

The body character image data B(j) stored in the row corresponding to the template specified in the object template storage region 201 is read in the processing (4) (step S510), and thus the body character conversion processing (S204) is completed.

Thereafter, a processing of combining the head character image A(i) read in step S202 and the body character image B(j) read in step S204 is performed (step S204). That is, the head character image A(i) is combined with the top end of the body character image B(j) thereby to create a whole body character image. Then, the created whole body character image data is transmitted to the digital camera 1 (step S206).

Then, the digital camera 1 receives the whole body character image data transmitted from the image service site 530 and displays it on the liquid crystal display panel 3, and stores it in the internal memory 14 or the memory card 60 (step S109).

Thus, according to the present embodiment, a character image added with a characteristic different from the characteristic of the subject person can be easily and rapidly created. Additionally, in the present embodiment, the characteristic of the subject person's face is reflected on the characteristic of the head of the character image, and thus a character image added with the characteristic of the subject person and a characteristic different therefrom can be easily and rapidly created.

That is, as illustrated in FIG. 13, when a person 601 is shot with the first shutter key operation, a face image 602 is subjected to the clip processing to be transmitted from the digital camera 1 to the image service site 530. Then, the image service site 530 receives the same, and converts it by using the first DB 100 into a head character image (made of the neck and the head including hair) 603 according to the characteristic of the face image 602.

When a kiwifruit 604 is positioned within the cursor C to be shot with the second shutter key operation, the image part of the kiwifruit 604 is subjected to the clip processing to be transmitted from the digital camera 1 to the image service site 530. Then, the image service site 530 receives the same, and converts it using the second DB 200 into a body character image 605 according to the characteristic of the kiwifruit 604. Thereafter, the image service site 530 combines the head character image 603 and the body character image 605 to create a whole body character image 606, and transmits the same to the digital camera 1.

Thus, a character image having the face image 602 of the subject person and added with the characteristic of the kiwifruit 604 as an object different therefrom can be easily and rapidly created.

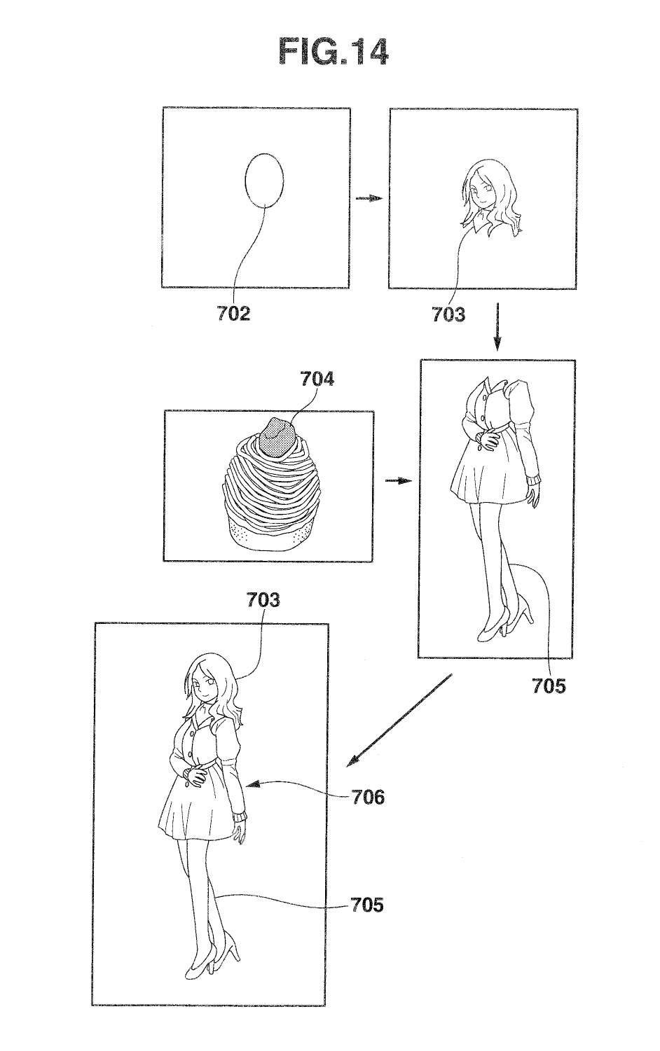

As illustrated in FIG. 14, when a person is shot with the first shutter key operation, the face image 702 is subjected to the clip processing to be transmitted from the digital camera 1 to the image service site 530. Then, the image service site 530 receives the same and converts it using the first DB 100 into a head character image 703 according to the characteristic of the face image 702.

When a cake 704 is positioned within the cursor C to be shot with the second shutter key opera-ion, the image of the cake 704 is subjected to the clip processing to be transmitted from the digital camera 1 to the image service site 530. Then, the image service site 530 receives the same, and converts it by using the second DB 200 into a body character image 705 according to the characteristic of the cake 704. Thereafter, the image service site 530 combines the head character image 703 and the body character image 705 to create a whole body character image 706, and transmits it to the digital camera 1.

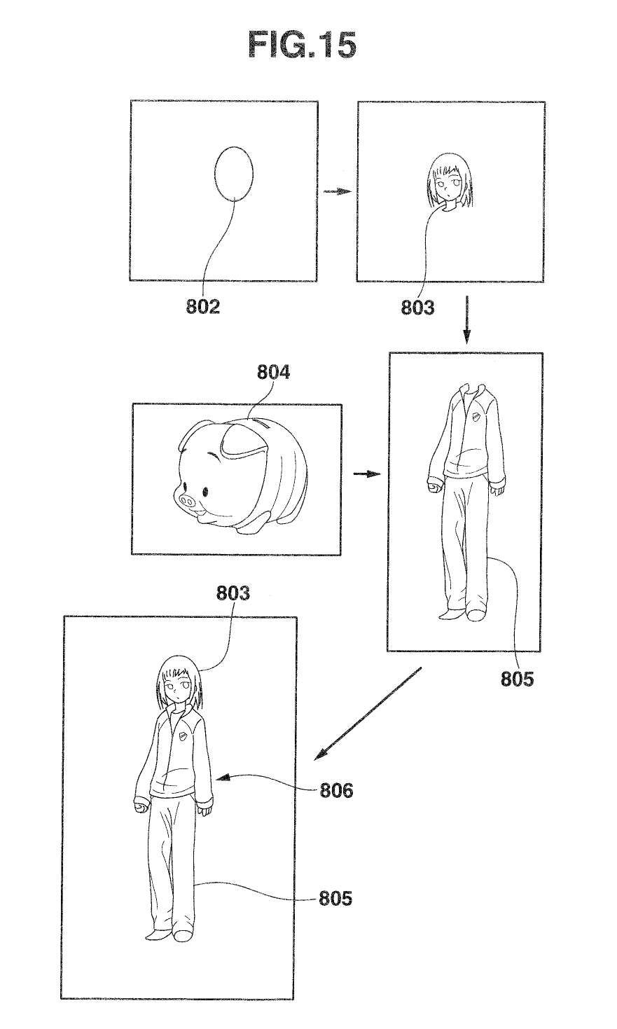

As illustrated in FIG. 15, when a person is shot with the first shutter key operation, the face image 802 is subjected to the clip processing to be transmitted from the digital camera 1 to the image service site 530. Then, the image service site 530 receives the same, and converts it by using the first DB 100 into a head character image 803 according to the characteristic of the face image 802.

When a piggy bank 804 is positioned within the cursor C to be shot with the second shutter key operation, the image of the piggy bank 804 is subjected to the clip processing to be transmitted from the digital camera 1 to the image service site 530. Then, the image service site 530 receives the same, and converts it by using the second DB 200 into a body character image 805 according to the characteristic of the piggy bank 804. Thereafter, the image service site 530 combines the head character image 803 and the body character image 805 to create a whole body character image 806, and transmits it to the digital camera 1.

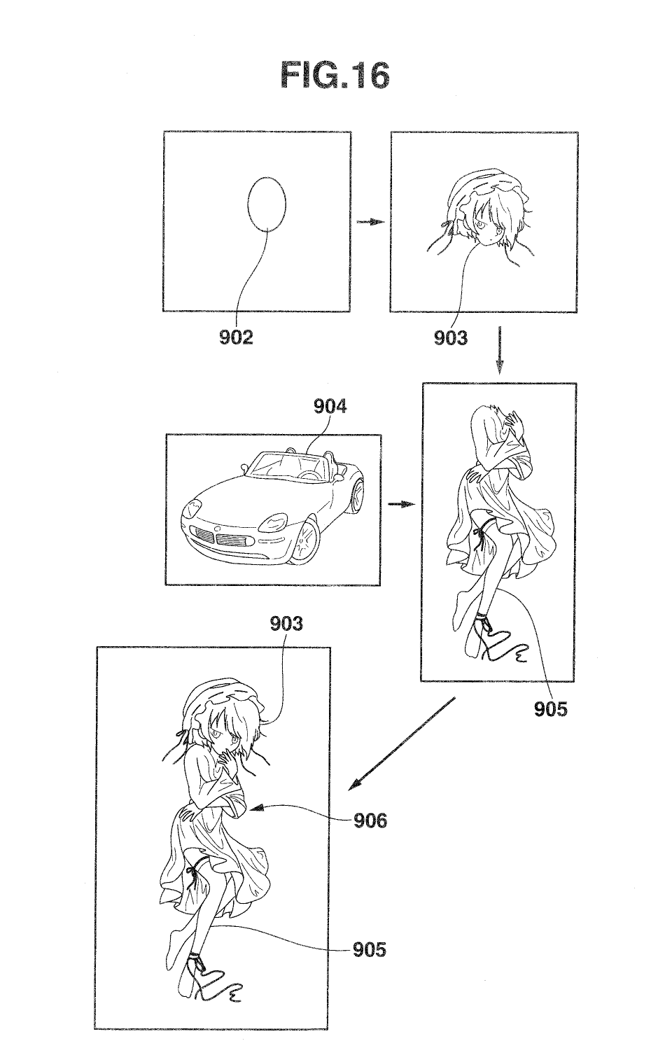

As illustrated in FIG. 16, when a person is shot with the first shutter key operation, the face image 902 is subjected to the clip processing to be transmitted from the digital camera 1 to the image service site 530. Then, the image service site 530 receives the same, and converts it by using the first DB 100 into a head character image 903 according to the characteristic of the face image 902.

When a vehicle 904 is positioned within the cursor C to be shot with the second shutter key operation, the image of the vehicle 904 is subjected to the clip processing to be transmitted from the digital camera 1 to the image service site 530. Then, the image service site 530 receives the same, and converts it by using the second DB 200 into a body character image 905 according to the characteristic of the vehicle 904. Thereafter, the image service site 530 combines the head character image 903 and the body character image 905 to create a whole body character image 906, and transmits it to the digital camera 1.

Thus, a character image having a characteristic of the face image 602 of the subject person and added with the characteristics of the cake 704, the piggy bank 804 and the vehicle 905 as the objects different therefrom can be easily and rapidly created as shown in FIGS. 14, 15, and 16.

In the present embodiment, the digital camera 1 and the image service site 530 are combined, but the present invention may be embodied by only the digital camera 1. In this case, the first DB 100 and the second DB 200 are previously provided inside the ROM 12, and the processing according to the flowchart illustrated in FIG. 5 may be executed by the CPU 11 in the digital camera 1.

The explanation has been made by way of a digital camera, but the present invention is applicable to a digital equipment and the like having a camera.

A face image may be clipped out by tracing a contour of the face image with a finger or pen on a touch panel.

The face character images and the body character images may be additionally written into the first DB 100 and the second DB 200, and may be posted by the user.

A subject person and an object may not be shot at the same time, and a photograph of the subject person and the object previously stored may be used.

The case where a subject person is to be converted into a character image is demonstrated in the embodiment, but not only persons but also other subjects may be employed.

The embodiment of the present invention has been described above, but the present invention is not limited to the above and encompasses the invention described in the claims and their equivalents.

According to the embodiment of the present invention, when a person's photograph is to be converted into a character image, an object which differs from the person is shot and a characteristic of the object can be reflected thereon, thereby intuitively creating a character image.

For example, by way of an image, when the object is a “round, green kiwifruit”, a character image of a “woman in green clothes and with round face and short hair” is created; when the object is a “cake”, a character image of a “woman in a beige airy dress” is created; when the object is a “pink piggy bank”, a character image of a “woman relaxing in a pink housedress” is created; and when the object is a “silver vehicle”, a character image of a “monotone, sporty woman” is created, thus a character image can be intuitively created, providing a new form of fun.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein. For example, the present invention can be practiced as a computer readable recording medium in which a program for allowing the computer to function as predetermined means, allowing the computer to realize a predetermined function, or allowing the computer to conduct predetermined means.

What is claimed is:

1. An image processing method, comprising:
shooting a subject and an object different from the subject;
extracting a characteristic of the object; and
converting an image of the subject into a character image according to the extracted characteristic of the object.

2. The image processing method according to claim 1, wherein the subject comprises a person.

3. The image processing method according to claim 2, wherein the converting comprises:
dividing the image of the subject into a face and a remaining portion;
converting images of the remaining portion into a partial image according to the characteristic of the object; and
combining the face image and the partial image.

4. The image processing method according to claim 1, wherein the characteristic comprises at least one of a hue, a saturation, a brightness, a contour, and a size.

5. The image processing method according to claim 1, wherein
the characteristic comprises characteristic data indicative of at least one of a hue, a saturation, a brightness, a contour, and a size,
the characteristic data is between a minimum value and a maximum value,
the converting comprises converting the image of the subject into the character image according to the characteristic data when the extracted characteristic is between the minimum value and the maximum value.

6. The image processing method according to claim 1, wherein
the subject is first snot and the object is then shot.

7. An image processing apparatus comprising:
a shooting unit configured to shoot a subject and an object different from the subject;
an extracting unit configured to extract a characteristic of the object shot by the shooting unit; and
a converting unit configured to convert an image of the subject into a character image according to the characteristic of the object extracted by the extracting unit.

8. A non-transitory computer readable medium having stored thereon a computer program which is executed by a computer, the computer program controlling the computer to execute functions of:
shooting a subject and an object different from the subject;
extracting a characteristic of the object; and
converting an image of the subject into a character image according to the characteristic of the object.

9. An image processing system comprising a terminal and a server connected to the terminal via a network, wherein
the terminal comprises a shooting unit configured to shoot a subject and an object different from the subject, and
the server comprises:
an extracting unit configured to extract a characteristic of the object shot by the shooting unit;
a converting unit configured to convert an image of the subject shot by the shooting unit into a character image according to the characteristic of the object extracted by the extracting unit; and
a transmitting unit configured to transmit the character image converted by the converting unit to the terminal.
